(19) United States
(12) Patent Application Publication
(10) Pub. No.: US 2006/0201584 A1
(43) Pub. Date: Sep. 14, 2006

(54) Method of treating a surface

(76) Inventor: Rainer Seufferlein, Munich (DE)

Correspondence Address: CLARK HILL, P.C., 500 WOODWARD AVENUE, SUITE 3500, DETROIT, MI, 48226, US

(21) Appl. No.: 11/372,934

(22) Filed: Mar. 10, 2006

(30) Foreign Application Priority Data
Mar. 14, 2005 (DE) DE 102005013670.2

(51) Int. Cl. B32B 27/00

(52) U.S. Cl. 148/251; 428/421

(57) ABSTRACT

A method of treating a surface (13) of an aluminium component and an aluminium component of this kind are described. In the method described, a PTFE coating (16) is applied to the surface (13) of the aluminium component. The method described is used for example for treating the surface (13) of a decorative trim (10) on a motor vehicle.

### BACKGROUND OF THE INVENTION

1. Technical Field

The invention relates to a method of treating the surface of an aluminium component and an aluminium component treated in this way.

2. Description of the Related Art

Aluminium and aluminium alloys are widely used materials which are also used, for example, on the exteriors of motor vehicles. Aluminium components are also used as decorative trims. Because of their use on the exterior, it is essential that these components have a high corrosion resistance. To achieve this, it is normal to increase the resistance of the surface by anodic oxidation, thus producing an eloxal coating.

However, this measure is not always sufficient to ensure long term resistance commensurate with the service life of a motor vehicle.

It should also be noted that motor vehicles are regularly given a wax coating before delivery, which is intended to protect the outer skin of the vehicle during transportation. This coating has to be removed again before the vehicle is handed over to the buyer, and this is done using cleaning substances with pH levels in excess of 13. Furthermore, car washes use cleaning agents with high pH levels which also attack the surface of the vehicles.

Conventional eloxal processes, however, provide protection only from pH levels of more than 10.5, which means that the surfaces will be damaged during the removal of the wax coating.

Other known methods are based on the application of paint (e-coating, nanotechnology) and the use of silicates.

A method of producing a water-repellent surface on an eloxal coating produced by anodic oxidation on an aluminium component is known from the publication DE 10226737 A1. In this publication, the water-repellent surface is applied directly to the eloxal coating using at least one modified silane.

These known methods have a number of disadvantages. Thus, for example, the effect on health of using nanotechnology is not yet clear. The application of paint as a protective finish means that the output figures (proportion of perfect goods) deteriorate, as blemishes typical of paint and also the magnifying effect of the coat of paint give rise to rejects, particularly in the case of parts that are on view.

### SUMMARY OF THE INVENTION

The method according to the invention for protecting decorative trims envisages that at least one PTFE coating (PTFE: polytetrafluoroethylene) is applied to a surface of a decorative trim.

With this special coating it is possible for the aluminium component and especially its surface to withstand pH levels of more than 13. Thus, the component is guaranteed excellent corrosion resistance and hence long-term resistance.

The number of coats to be applied depends on the intended subsequent use. However, up to seven coats of PTFE may readily be applied.

The PTFE coating or coatings applied are absolutely clear and colorless. A thickness of about 3 μm for the coating or coatings has proved suitable.

Usually, on the aluminium component, an eloxal coating is first formed by anodic oxidation, for example. This eloxal coating confers additional protection and determines the external appearance of the aluminium component.

In a preferred embodiment, the PTFE coating is applied directly to the surface of the aluminium component or eloxal coating. If no additional base coat or no additional primer is used, this is advantageous, as in this case, the optical appearance of the aluminium surface is unaffected.

If no primer is used, it is advantageous to pretreat the surface of the aluminium component or the eloxal coating. This pretreatment ensures that the pores in the eloxal coating, particularly in the surface region, are enlarged so that firm anchoring of the PTFE coating to the surface is ensured.

If a primer is to be used, it is preferable to use a colorless primer so as not to interfere with the optical appearance of the treated surface.

The PTFE coating, like the primer, may be applied by a standard commercial process such as e.g. vaporization or spraying. Subsequent tempering causes the molecules applied to crosslink and ensures protection by a polymer seal which cannot be undermined.

The method according to the invention is preferably used on decorative trims of motor vehicles.

This method and particularly the preferred embodiments give rise to numerous advantages over known methods. It is thus possible to achieve high pH resistance in aluminium components with a small number of manufacturing steps. At the same time, high mechanical resistance is achieved. In contrast to known methods, the new method is environmentally friendly and thus acceptable in health terms. Even if damage occurs, e.g. scratches on the surface, it is easily removed.

The aluminium component according to the invention is characterized in that at least one PTFE coating is applied to its surface.

Usually, the aluminium component has an eloxal coating the surface of which forms the surface of the aluminium component.

The PTFE coating may be applied directly to the surface of the aluminium component or to the eloxal coating. In this case, the surface is preferably pretreated so that the aluminium component or the eloxal coating has larger pores in the surface region. These ensure a firm bond between the surface coating and the PTFE coating applied.

It is also readily possible to treat the surface initially with a base coat or a primer before applying the PTFE coating. In this case, a colorless primer is preferably used.

In order to protect it from external influences, the surface of the aluminium component is provided with a wax coating, particularly before transportation. This wax coating has to be removed again after transportation, using cleaning agents with high pH levels. During this cleaning step, the surface of the aluminium component is protected by the PTFE coating which in turn does not affect the optical appearance of the aluminium component.

The aluminium component according to the invention as described is preferably used as a decorative trim on a motor vehicle and is predominantly used in areas which are not prone to being hit by stones.

Further features and advantages of the invention will become apparent from the description and the accompanying drawings.

It will be appreciated that the features mentioned hereinbefore and those still to be described below may be used not only in the particular combination specified but also in other combinations or on their own without departing from the scope of the present invention.

### BRIEF DESCRIPTION OF THE DRAWINGS

The invention is schematically illustrated by exemplary embodiments shown in the drawings and is hereinafter described in detail with reference to the drawings.

FIG. 1 is a sectional view of an embodiment of the decorative trim according to the invention; and

FIG. 2 also shows a sectional view of another embodiment of the decorative trim according to the invention.

### DETAILED DESCRIPTION OF THE PREFERRED EMBODIMENT

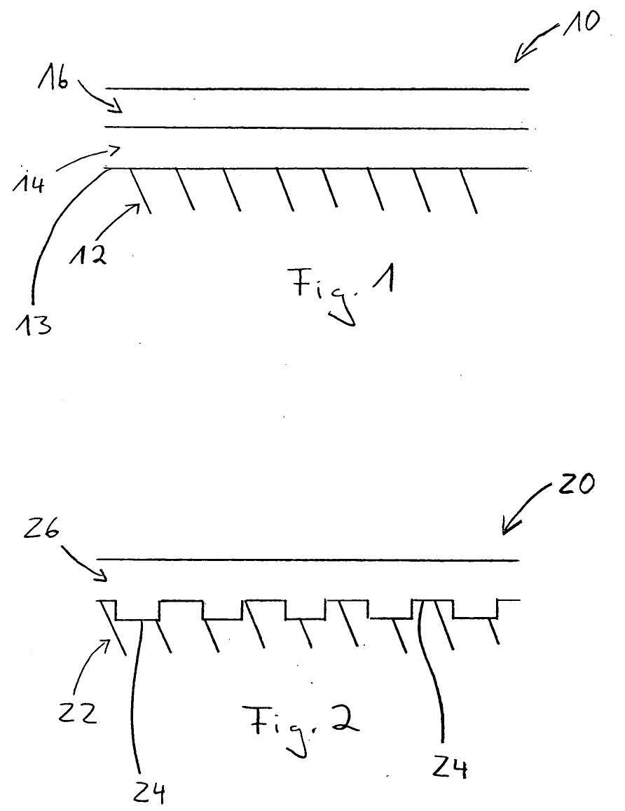

FIG. 1 shows a decorative trim according to the invention, generally designated 10. The section shows the different layers, namely, as the carrier material, an eloxal coating 12 with a surface 13 which is to be protected, and as the adhesive layer a base coat 14 (coat of primer) and as the functional layer a PTFE coating 16.

During manufacture, the decorative trim 10 made from an aluminium material is first subjected to oxidation so as to form the eloxal layer 12 shown. This eloxal layer 12, and especially its surface 13, are protected to some extent from external influences and give the decorative trim 10 its visual appearance.

As an additional protection, according to the invention, the PTFE coating 16 is provided as a so-called functional layer which offers effective protection for the surface 13. In order to bond the PTFE coating 16 to the eloxal coating 12, an intermediate base coat 14 is also provided which is applied, for example, by vapor deposition or spraying before the PTFE coating 16 is applied to the surface 13. A clear or colorless primer is preferably used for this base coat 14, so that the external appearance of the decorative trim 10 is unaffected.

The PTFE coating 16 is also colorless and confers resistance to substances with pH levels above 13. Thus, the decorative trim 10 is effectively protected from external conditions.

FIG. 2 shows another possible embodiment of the decorative trim according to the invention which is designated 20 in the Figure. An eloxal coating 22 with a pretreated surface 24 and a PTFE coating 26 are shown.

The surface 24 of the eloxal coating 22 is pretreated so as to achieve a different pore structure, namely enlarged pores, on which the PTFE coating 26, which is applied, for example, by vapor deposition or spraying and subsequent tempering, is securely anchored.

Thus, there is no need to apply a primer. The PTFE coating 26 is colorless, with the result that the optical appearance of the decorative trim 20 is determined exclusively by the surface 24 of the eloxal coating 22. Nevertheless, the PTFE coating 26 provides long term protection for the decorative trim 20.

In addition, the PTFE coating 26 applied is very easy to maintain and repair as damage such as scratches can easily be removed without the need to pass a current through, as in other processes such as the so-called e-coating method or methods in nanotechnology.

What is claimed is:

1. A method of treating a surface (13, 24) of an aluminium component, in which at least one PTFE coating (16, 26) is applied to the surface (13, 24).

2. The method according to claim 1, wherein oxidation produces an eloxal coating (12, 22), the surface (13, 24) of which forms the surface (13, 24) of the aluminium component.

3. The method according to claim 2, wherein the PTFE coating (16, 26) is applied directly to the surface (13, 24) of the aluminium component.

4. The method according to claim 3, wherein the surface (13, 24) of the aluminium component is pretreated.

5. The method according to claim 1, wherein a base coat (14) is applied to the surface (13, 24) of the aluminium component, and the PTFE coating (16, 26) is then applied thereto.

6. The method according to claim 1, wherein the PTFE coating (16, 26) is applied by vapor deposition.

7. The method according to claim 1, wherein the PTFE coating (16, 26) is applied by spraying.

8. The method according to claim 1, wherein after application of the PTFE coating (16, 26) tempering is carried out.

9. The method according to claim 4, wherein in a final step a wax coating is applied.

10. The method according to claim 9, which is used to treat the surface (13, 24) of a decorative trim (10, 20) of a motor vehicle.

11. An aluminium component having a surface (13, 24) to which is applied at least one PTFE coating (16, 26).

12. The aluminium component according to claim 11 further including an eloxal coating (12, 22) produced by oxidation, the surface (13, 24) of which forms the surface (13, 24) of the aluminium component.

13. The aluminium component according to claim 12, wherein the PTFE coating (16, 26) is applied directly to the surface (13, 24).

14. The aluminium component according to claim 12, wherein the surface (13, 24) is pretreated.

15. The aluminium component according to claim 12, wherein a base coat (14) is applied between the surface (13, 24) and the PTFE coating (16, 26).

16. The aluminium component according to claim 12, wherein a wax coating is applied to the PTFE coating (16, 26).

17. The aluminium component according to claim 12, which is used as a decorative trim (10, 20) on a motor vehicle.
